(19) United States
(12) Patent Application Publication
(10) Pub. No.: US 2006/0192998 A1
(43) Pub. Date: Aug. 31, 2006

(54) Message display control apparatus

(75) Inventors: Toshihiro Shima, Nagano-ken (JP); Akira Matsumoto, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/359,506

(22) Filed: Feb. 23, 2006

(30) Foreign Application Priority Data
Feb. 24, 2005 (JP) 2005-48296

(51) Int. Cl. G06F 3/12

(52) U.S. Cl. 358/1.15

(57) ABSTRACT

In a message display control apparatus of the invention, when an administrator of a server computer presses a ‘Details’ button on a setting window displayed on the screen of a display unit, a message display setting module of a CPU in the server computer opens a detailed setting window on the screen of the display unit. The administrator operates an input unit to tick any desired checkboxes among an ‘On end of printing at all printers’ checkbox, an ‘On error’ checkbox, an ‘On end of printing at each printer’ checkbox, and a ‘Show copy number at the begging of copy mode printing’ checkbox, in a ‘Report Clustering status’ field on the detailed setting window. Such selective ticking specifies permission for display of messages corresponding to the ticked checkboxes among preset four messages on the monitor screen of a client computer. This arrangement enables display of only the desired messages on the monitor screen of the client computer and accordingly relieves the user of the client computer from feeling annoyed with frequent display of unnecessary messages.

### BACKGROUND OF THE INVENTION

1. Field of the Invention

The present invention relates to a technique adopted in distributed printing with multiple printing devices to selectively specify permission or prohibition for display of a message corresponding to an operating status of each printing device, on a preset device.

2. Description of the Related Art

In distributed printing of a certain print job sent from a client computer to multiple printers via a server computer, in response to the occurrence of any of preset events in each of the multiple printers, the server computer is notified of the occurrence of the event. The server computer then sends a message representing the occurrence of the event to the client computer and causes the message to be displayed on the monitor screen of the client computer.

A known system of distributed printing with multiple printers is disclosed, for example, in Japanese Patent Laid-Open Gazette No. 2002-215369.

In response to the occurrence of an event in each printer, the prior art technique causes a corresponding message to be displayed on the monitor screen of the client computer, irrespective of the user's requirement. The user may thus feel annoyed with frequent display of unnecessary messages.

### SUMMARY OF THE INVENTION

The object of the invention is thus to eliminate the drawbacks of the prior art technique and to provide a technique of enabling display only the user's desired messages.

In order to attain at least part of the above and the other related objects, the present invention is directed to a message display control apparatus that is adopted in distributed printing with multiple printing devices to enable a message corresponding to an operating status of each printing device to be displayed on an own device of the message display control apparatus or another device. The message display control apparatus includes: a display unit; and a message display setting module that displays a setting window on the display unit, where the setting window enables a user to select either permission or prohibition for display of at least one of four messages on the own device of the message display control apparatus or another device:

A. a first message to notify completion of printing a preset total number of required copies with regard to a certain print job by all the multiple printing devices;

B. a second message to notify occurrence of an error interfering with completion of printing in one of the multiple printing devices;

C. a third message to notify completion of printing a preset distributed number of required copies with regard to a certain print job by one of the multiple printing devices; and

D. a fourth message to notify setting of copy printing for a certain print job and specification of a total number of required copies with regard to the certain print job to be printed by the multiple printing devices.

In the message display control apparatus of the invention, the setting window is displayed on the display unit to enable the user to select either permission or prohibition for display of at least one message among the four messages. The user can thus give permission for display only the user's desired messages.

The message display control apparatus of the invention enables display of only the user's desired messages on the own device of the message display control apparatus or another device. This arrangement effectively relieves the user from feeling annoyed with frequent display of unnecessary messages.

In one preferable embodiment of the invention, the message display control apparatus further has a message display control module that, in response to the user's permission for display with regard to any of the four messages, enables the message with the user's permission corresponding to the operating status of each printing device to be displayed on the own device of message display control apparatus or another device.

The message display control apparatus with the message display control module enables only the message with the user's permission corresponding to the operating status of each printing device to be displayed on the own device of the message display control apparatus or another device.

The technique of the invention is not restricted to the message display control apparatus but is also applicable to a corresponding message display setting method. There are other diverse applications of the invention, for example, computer programs to establish the message display control apparatus and the message display setting method, recording media in which such computer programs are recorded, and data signals that include such computer programs and are embodied in carrier waves.

### BRIEF DESCRIPTION OF THE DRAWINGS

FIG. 1 schematically illustrates the configuration of a distributed printing system including a message display control apparatus in one embodiment of the invention;

FIG. 2 is a block diagram showing the schematic structure of a server computer functioning as the message display control apparatus of the embodiment;

FIGS. 3(A) through 3(D) show examples of messages sent from the server computer to a client computer; and

FIGS. 4(A) and 4(B) show setting windows opened to specify either permission or prohibition for display of messages.

### DESCRIPTION OF THE PREFERRED EMBODIMENTS

One mode of carrying out the invention is described below as a preferred embodiment in the following sequence:

A. Configuration of Distributed Printing System

B. General Operations of Distributed Printing System

C. Structure of Server Computer

D. Operations of Server Computer

E. Effects of Embodiment

F. Modifications

A. Configuration of Distributed Printing System

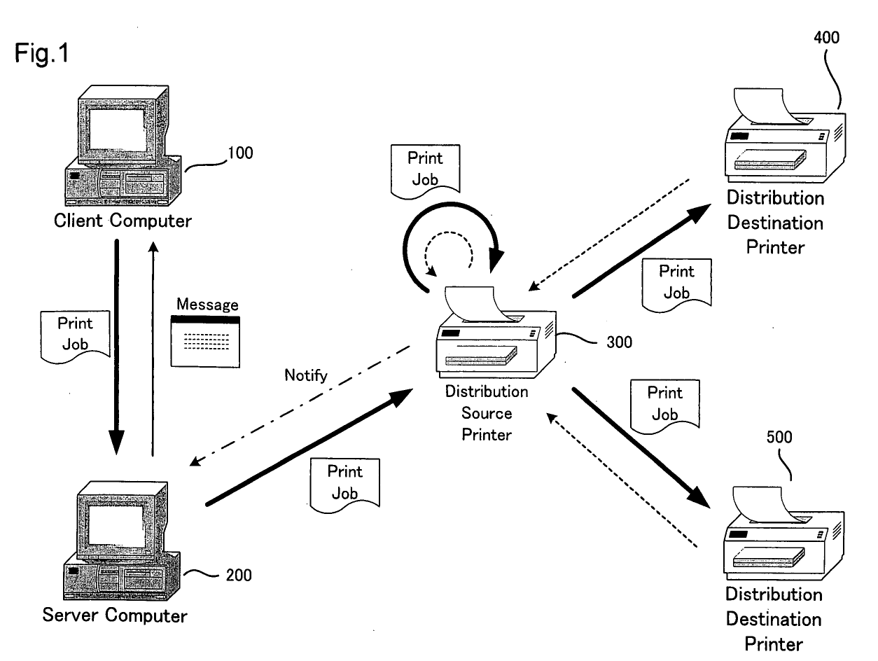

FIG. 1 schematically illustrates the configuration of a distributed printing system including a message display control apparatus in one embodiment of the invention. As illustrated in FIG. 1, the distributed printing system includes a client computer 100, a server computer 200 functioning as the message display control apparatus of the embodiment, a distribution source printer 300, and distribution destination printers 400 and 500, which are interconnected via a network.

B. General Operations of Distributed Printing System

In the distributed printing system, the client computer 100 sends a print job as an object of distributed printing to the server computer 200. The server computer 200 relays the print job to the distribution source printer 300. The distribution source printer 300 receives a header portion of the relayed print job, extracts data on the number of required copies from the received header portion of the print job, specifies distribution destinations among available printers for distributed printing on the network, and sets the distributed numbers of required copies to be printed by the respective distribution destinations. In this illustrated example, the distribution source printer 300 specifies the distribution source printer 300 itself and the distribution destination printers 400 and 500 as the distribution destinations. The distribution source printer 300 then receives a residual portion of the relayed print job and delivers divisions of the print job to the respective distribution destinations. Each of the distribution source printer 300 and the distribution destination printers 400 and 500 specified as the distribution destinations prints the distributed number of required copies according to the delivered division of the print job.

The distributed printing has two different modes, an ordinary mode and a copy mode. In the ordinary mode, the distribution source printer 300 allocates the distributed numbers of required copies to the respective distribution destinations to make the sum of the distributed numbers of required copies equal to the number of required copies extracted from the header portion of the relayed print job. In the copy mode, the distribution source printer 300 allocates the distributed numbers of required copies to the respective distribution destinations to make each distributed number of required copies equal to the number of required copies extracted from the header portion of the relayed print job. In the copy mode, the total number of printed copies changes in proportion to the number of printers specified by the distribution source printer 300 as the distribution destinations.

The distribution source printer 300 stores in advance report items information and report timing information. The distribution source printer 300 monitors the print status in each printer specified as the distribution destination at preset time intervals corresponding to the report timing information. The distribution source printer 300 monitors each printer specified as the distribution destination with regard to report items set in the report items information and, in response to detection of the occurrence of an event corresponding to any of the report items, notifies the server computer 200 of the occurrence of the event and the details of the event. Typical examples of the report items set in the report items information include ‘completion of printing in all printers specified as distribution destinations’ , ‘occurrence of an error to interfere with completion of printing in one of printers specified as distribution destination’, ‘completion of printing in one of printers specified as distribution destination’, and ‘selection of copy mode and specification of printers as distribution destinations’.

The server computer 200 receives the notification from the distribution source printer 300 and sends a message corresponding to the notification to the client computer 100. The client computer 100 receives the message and displays the received message on a monitor screen of the client computer 100 to inform the user of the occurrence and the details of an event.

C. Structure of Server Computer

The server computer 200 functioning as the message display control apparatus of the embodiment is described more in detail.

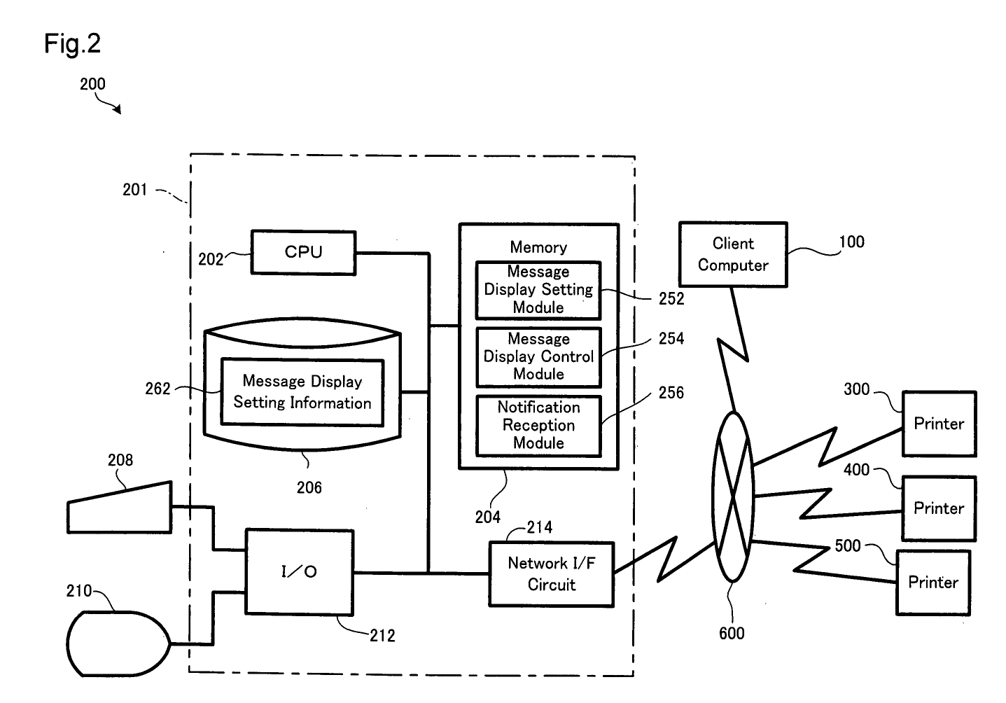

FIG. 2 is a block diagram showing the schematic structure of the server computer 200 functioning as the message display control apparatus of the embodiment. As illustrated in FIG. 2, the server computer 200 includes a computer main body 201, an input unit 208, for example, a keyboard and a pointing device, connected to the computer main body 201, and a display unit 210, such as a monitor, connected to the computer main body 201. The server computer 200 is connected with the client computer 100 and the printers 300 to 500 via a network 600.

The computer main body 201 includes a CPU 202 that executes various processing and controls according to programs, a memory 204 that stores programs and data obtained in the course of processing, a hard disk unit 206 that stores diverse programs and data, an I/O circuit 212 that transmits data and signals to and from external components outside the computer main body 201, and a network I/F circuit 214 that transmits data to and from external devices outside the server computer 200 via the network 600. These constituents of the computer main body 201 are interconnected via a bus.

The CPU 202 executes a message display processing program among the programs stored in the memory 204 to perform the functions of a message display setting module 252, a message display control module 254, and a notification reception module 256 discussed later. The message display processing program is typically given as an application program, but may be constructed as part of an operating system program.

The display unit 210, the message display setting module 252, the message display control module 254, and an administrator of the server computer 200 (described later) in the message display control apparatus of the embodiment are respectively equivalent to the display unit, the message display setting module, the message display control module, and the user of the invention.

The hard disk unit 206 stores message display setting information 262.

D. Operations of Server Computer

The server computer 200 is notified by the distribution source printer 300 of the occurrence of an event corresponding to one of the report items and the details of the vent and sends a message corresponding to the notification to the client computer 100.

According to a concrete procedure, when the network I/F circuit 214 receives the notification from the distribution source printer 300 via the network 600, the notification reception module 256 of the CPU 202 acquires and analyzes the received notification. The message display control module 254 then creates a message based on the result of the analysis.

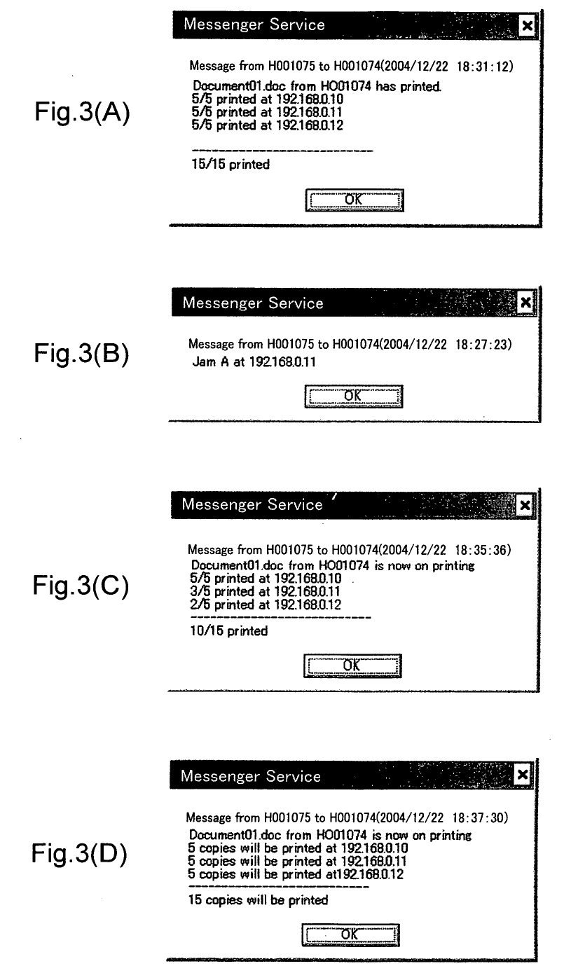

FIGS. 3(A) through 3(D) show examples of messages sent from the server computer 200 to the client computer 100.

In one example, when the notification from the distribution source printer 300 represents ‘completion of printing in all printers specified as distribution destinations’, the notification reception module 256 analyzes the notification and obtains information on the name of a print job of interest, IP addresses of the printers specified as the distribution destinations, and numbers of copies printed by the respective distribution destinations, from the details of the event included in the analyzed notification. The message display control module 254 creates a message as shown in FIG. 3(A) based on the obtained pieces of information and controls the network I/F circuit 214 to send the message to the client computer 100 via the network 600. The client computer 100 receives the message and displays the received message on its monitor screen.

The message shown in FIG. 3(A) mainly describes:

1. Identification of the server computer 200 as a message sender and the client computer 100 as a message receiver, where ‘H001075’ and ‘H001074’ respectively represent the name of the server computer 200 and the name of the client computer 100;

2. Completion of a print job sent from the client computer 100, where ‘Document01.doc’ represents the name of the print job;

3-1. Completion of printing 5 copies as the number of printed copies relative to 5 copies as the distributed number of required copies by the printer 300 specified as the distribution destination, where ‘192.168.0.10’ represents an IP address of the printer 300 specified as the distribution destination;

3-2. Completion of printing 5 copies as the number of printed copies relative to 5 copies as the distributed number of required copies by the printer 400 specified as the distribution destination, where ‘192.168.0.11’ represents an IP address of the printer 400 specified as the distribution destination;

3-3. Completion of printing 5 copies as the number of printed copies relative to 5 copies as the distributed number of required copies by the printer 500 specified as the distribution destination, where ‘192.168.0.12’ represents an IP address of the printer 500 specified as the distribution destination; and

4. Completion of printing 15 copies as the total number of printed copies relative to 15 copies as the total number of required copies for printing.

In another example, when the notification from the distribution source printer 300 represents ‘occurrence of an error to interfere with completion of printing in one of printers specified as distribution destination’, the notification reception module 256 analyzes the notification and obtains information on an IP address of the printer as the distribution destination with an error and the details of the error, from the details of the event included in the analyzed notification. The message display control module 254 creates a message as shown in FIG. 3(B) based on the obtained pieces of information and controls the network I/F circuit 214 to send the message to the client computer 100 via the network 600. The client computer 100 receives the message and displays the received message on its monitor screen.

The message shown in FIG. 3(B) mainly describes:

1. Identification of the server computer 200 as a message sender and the client computer 100 as a message receiver; and

2. Occurrence of an A-type paper jam in the printer 400 specified as the distribution destination.

In still another example, when the notification from the distribution source printer 300 represents ‘completion of printing in one of printers specified as distribution destination’, the notification reception module 256 analyzes the notification and obtains information on a the name of a print job of interest, IP addresses of the printers specified as the distribution destinations, and numbers of copies printed by the respective distribution destinations, from the details of the event included in the analyzed notification. The message display control module 254 creates a message as shown in FIG. 3(C) based on the obtained pieces of information and controls the network I/F circuit 214 to send the message to the client computer 100 via the network 600. The client computer 100 receives the message and displays the received message on its monitor screen.

The message shown in FIG. 3(C) mainly describes:

1. Identification of the server computer 200 as a message sender and the client computer 100 as a message receiver;

2. In-printing status of a print job sent from the client computer 100;

3-1. Completion of printing 5 copies as the number of printed copies relative to 5 copies as the distributed number of required copies by the printer 300 specified as the distribution destination;

3-2. Completion of printing 3 copies as the number of printed copies relative to 5 copies as the distributed number of required copies by the printer 400 specified as the distribution destination;

3-3. Completion of printing 2 copies as the number of printed copies relative to 5 copies as the distributed number of required copies by the printer 500 specified as the distribution destination; and

4. Completion of printing 10 copies as the total number of printed copies relative to 15 copies as the total number of required copies for printing.

In another example, when the notification from the distribution source printer 300 represents ‘selection of copy mode and specification of printers as distribution destinations’, the notification reception module 256 analyzes the notification and obtains information on the name of a print job of interest, IP addresses of the printers specified as the distribution destinations, and distributed numbers of required copies to be printed by the respective distribution destinations, from the details of the event included in the analyzed notification. The message display control module 254 creates a message as shown in FIG. 3(D) based on the obtained pieces of information and controls the network I/F circuit 214 to send the message to the client computer 100 via the network 600. The client computer 100 receives the message and displays the received message on its monitor screen.

The message shown in FIG. 3(D) mainly describes:

1. Identification of the server computer 200 as a message sender and the client computer 100 as a message receiver;

2. In-printing status of a print job sent from the client computer 100;

3-1. Setting 5 copies to the distributed number of required copies to be printed by the printer 300 specified as the distribution destination;

3-2. Setting 5 copies to the distributed number of required copies to be printed by the printer 400 specified as the distribution destination;

3-3. Setting 5 copies to the distributed number of required copies to be printed by the printer 500 specified as the distribution destination; and

4. Setting 15 copies to the total number of required copies.

The server computer specifies the client computer 100 as the message receiver according to the following procedure.

The client computer 100 utilizes a printer driver to create a print job and writes the own machine name, that is, the machine name of the client computer 100, in the header portion of the print job. When the print job is eventually supplied to each printer specified as a printing execution printer, print job information is reflected on a job MIB in an externally obtainable manner. The server computer 200 sends a command ‘Get Request’ to the job MIB to obtain the machine name of the client computer 100 as a print request sender of the print job and sends an adequate message to the client computer 100 based on the obtained machine name.

Diverse messages are sent from the server computer 200 to the client computer 100 and are successively pop-up displayed on the monitor screen of the client computer 100. The user of the client computer 100 may feel annoyed with the frequent pop-up display of the diverse messages.

For relieving such annoyance of the user of the client computer 100, the structure of this embodiment enables the administrator of the server computer 200 to selectively enable or disable the display of these messages on the monitor screen of the client computer 100.

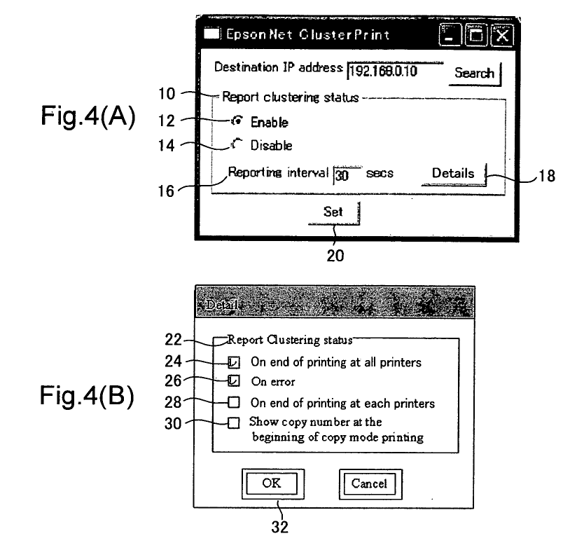

FIGS. 4(A) and 4(B) show setting windows opened to specify either permission or prohibition for display of messages.

The administrator of the server computer 200 operates the input unit 208 to give a start command of message display setting to the server computer 200. The message display setting module 252 of the CPU 202 opens a setting window shown in FIG. 4(A) on the screen of the display unit 210. The administrator manipulates the input unit 208 to selectively click either a radio button 12 ‘Enable’ or a radio button 14 ‘Disable’ in a ‘Report clustering status’ field 10 on the setting window. The administrator's selective click of the radio buttons 12 and 14 specifies permission or prohibition for display of messages on the monitor screen of the client computer 100.

When the administrator clicks the radio button 14 ‘Disable’ and presses a ‘Set’ button 20, the message display setting module 252 specifies prohibition for display of any of the four messages on the monitor screen of the client computer 100. The message display setting module 252 then writes the setting of display-off with regard to all the four messages into the message display setting information 262 stored in the hard disk unit 206.

When the administrator clicks the radio button 12 ‘Enable’ and presses the ‘Set’ button 20, on the other hand, the message display setting module 252 specifies permission for display of selected ones of the four messages on the monitor screen of the client computer 100. The message display setting module 252 then activates a ‘Reporting interval’ field 16 and a ‘Details’ button 18. At a reporting interval specified in the ‘Reporting interval’ field 16, the distribution source printer 300 monitors the print status in each printer specified as the distribution destination. The administrator operates the input unit 208 to enter a desired time period (seconds) in the ‘Reporting interval’ field 16 and presses the ‘Set’ button 20. The message display setting module 252 then writes the entered time period into the message display setting information 262. In response to the administrator's press of the ‘Details’ button 18, the message display setting module 252 opens a detailed setting window shown in FIG. 4(B) on the screen of the display unit 210.

The administrator operates the input unit 208 to tick any desired checkboxes among an ‘On end of printing at all printers’ checkbox 24, an ‘On error’ checkbox 26, an ‘On end of printing at each printer’ checkbox 28, and a ‘Show copy number at the begging of copy mode printing’ checkbox 30, in a ‘Report Clustering status’ field 22 on the detailed setting window shown in FIG. 4(B). Such selective ticking specifies permission for display of messages corresponding to the ticked checkboxes among the four messages on the monitor screen of the client computer 100.

The ‘On end of printing at all printers’ checkbox 24, the ‘On error’ checkbox 26, the ‘On end of printing at each printer’ checkbox 28, and the ‘Show copy number at the begging of copy mode printing’ checkbox 30 respectively correspond to the message of FIG. 3(A), the message of FIG. 3(B), the message of FIG. 3(C), and the message of FIG. 3(D). In the illustrated example of FIG. 4(B), the ‘On end of printing at all printers’ checkbox 24 and the ‘On error’ checkbox 26 are ticked.

When the administrator ticks the desired checkboxes and sequentially presses an ‘OK’ button 32 on the detailed setting window of FIG. 4(B) and the ‘Set’ button 20 on the setting window of FIG. 4(A), the message display setting module 252 writes the setting of display-on with regard to the selected messages corresponding to the ticked checkboxes among the four messages and the setting of display-off with regard to the other messages into the message display setting information 262 stored in the hard disk unit 206.

On completion of setting for the display on the setting windows of FIG. 4, the message display setting module 252 refers to the message display setting information 262 stored in the hard disk unit 206 and controls the network I/F circuit 214 to send report items setting information and report timing setting information to the distribution source printer 300 via the network 600. The message display setting module 252 sends the report items corresponding to the messages with the display-on setting in the message display setting information 262, as the report items setting information. The message display setting module 252 also sends the time period written in the message display setting information 262 corresponding to the entry in the ‘Reporting interval’ field 16, as the report timing setting information.

The distribution source printer 300 sets the report items information and the report timing information, based on the received report items setting information and the received report timing setting information. The distribution source printer 300 accordingly monitors the print status in each printer specified as the distribution destination at the time intervals corresponding to the administrator's entry in the ‘Reporting interval’ field 16 on the setting window of FIG. 4(A). The distribution source printer 300 monitors the print status in each printer specified as the distribution destination with regard to only the administrator's selected report items corresponding to the ticked checkboxes on the detailed setting window of FIG. 4(B) and, on detection of each event in any of the selected report items, notifies the server computer 200 of the occurrence and the details of the event. The report items corresponding to the non-ticked checkboxes on the detailed setting window of FIG. 4(B) are excluded from the target of monitoring and notification.

The message display control module 254 of the server computer 200 generates corresponding messages with regard to only the report items notified by the distribution source printer 300 and sends the messages to the client computer 100. Only the messages corresponding to the ticked checkboxes on the detailed setting window of FIG. 4(B) are accordingly pop-up displayed on the monitor screen of the client computer 100.

E. Effects of Embodiment

The message display control apparatus of the embodiment enables selective display of only the messages desired by the administrator of the server computer 200 or by the user of the client computer 100 on the monitor screen of the client computer 100. This arrangement desirably relieves the user of the client computer 100 from feeling annoyed with frequent pop-up display of unnecessary messages.

F. Modifications

The embodiment discussed above is to be considered in all aspects as illustrative and not restrictive. There may be many modifications, changes, and alterations without departing from the scope or spirit of the main characteristics of the present invention. Some examples of possible modification are given below.

In the message display control apparatus of the embodiment, the distribution source printer 300 monitors the print status in each printer specified as the distribution destination with regard to only the selected report items corresponding to the ticked checkboxes on the detailed setting window of FIG. 4(B) and notifies the server computer 200 of the occurrence and the details of each event in any of the selected report items. The report items corresponding to the non-ticked checkboxes on the detailed setting window of FIG. 4(B) are excluded from the target of monitoring and notification. This arrangement is, however, not restrictive. The distribution source printer 300 may monitor the print status in each printer specified as the distribution destination with regard to all the report items and notify the server computer 200 of the occurrence and the details of each event in any of these report items. In this modified arrangement, the notification reception module 256 of the server computer 200 identifies whether each received notification regards one of the selected report items corresponding to the ticked checkboxes on the detailed setting window of FIG. 4(B). Only on the identified notification regarding one of the selected report items, the message display control module 254 generates a corresponding message and sends the message to the client computer 100. This modified arrangement accordingly enables display of only the messages corresponding to the ticked checkboxes on the detailed setting window of FIG. 4(B) on the monitor screen of the client computer 100, thus relieving the user from feeling annoyed with frequent pop-up display of unnecessary messages.

The message display control apparatus of the embodiment has the server computer 200 constructed separately from the client computer 100. One modified structure may incorporate the functions of the server computer 200 into the client computer 100 and omit the server computer 200. The client computer 100 functioning as the message display control apparatus opens the setting windows of FIGS. 4(A) and 4(B) on its monitor screen in the message display setting process.

In the configuration of the embodiment with the server computer 200 constructed separately from the client computer 100, the server computer 200 sends messages to all client computers having machine names obtained from a job MIB of each print job. In the modified configuration with the client computer 100 having the incorporated functions of the server computer 200, the client computer 100 as the message display control apparatus automatically obtains the own machine name. The detailed setting window of FIG. 4(B) may have an additional checkbox ‘Send report to only this machine’. Selective ticking in this additional checkbox by the user of the client computer 100 enables selection of either an option of sending the report only to the client computer 100 or an option of sending the report to all the client computers including the client computer 100.

This modified arrangement enables the user of each client computer to readily select either the display of messages only with regard to print jobs sent from the own client computer or the display of messages with regard to print jobs sent from other client computers and relayed by the own client computer as well as those sent from the own client computer. The user has no difficulties in setting the desired display. This arrangement enables the user of each client computer to receive the messages as the monitoring report with regard to only the own print jobs requested by the user. The user is not required to enter the machine name of the client computer but is required to simply tick the checkboxes of desired report items. This desirably relieves the user's load.

In the message display control apparatus of the embodiment, the detailed setting window of FIG. 4(B) includes the four options with the checkboxes corresponding to the four messages shown in FIG. 3. The detailed setting window may include three or a less number of options corresponding to selected ones of the four messages or include any additional options corresponding to messages other than the four messages. The checkboxes used for the selected specification of permission or prohibition for display may be replaced by radio buttons or any other suitable selection techniques.

Finally the present application claims the priority based on Japanese Patent Application No. 2005-048296 filed on Feb. 24, 2005, which is herein incorporated by reference.

What is claimed is:

1. A message display control apparatus that is adopted in distributed printing with multiple printing devices to enable a message corresponding to an operating status of each printing device to be displayed on an own device of the message display control apparatus or another device,
the message display control apparatus comprising:
a display unit; and
a message display setting module that displays a setting window on the display unit, where the setting window enables a user to select either permission or prohibition for display of at least one of four messages on the own device of the message display control apparatus or another device:
A. a first message to notify completion of printing a preset total number of required copies with regard to a certain print job by all the multiple printing devices;
B. a second message to notify occurrence of an error interfering with completion of printing in one of the multiple printing devices;
C. a third message to notify completion of printing a preset distributed number of required copies with regard to a certain print job by one of the multiple printing devices; and
D. a fourth message to notify setting of copy printing for a certain print job and specification of a total number of required copies with regard to the certain print job to be printed by the multiple printing devices.

2. A message display control apparatus in accordance with claim 1, the message display control apparatus further comprising:
a message display control module that, in response to the user's permission for display with regard to any of the four messages, enables the message with the user's permission corresponding to the operating status of each printing device to be displayed on the own device of the message display control apparatus or another device.

3. A message display setting method that is adopted in distributed printing with multiple printing devices to selectively specify either permission or prohibition for display of a message corresponding to an operating status of each printing device, on a preset device,
the message display setting method comprising the steps of
providing a display unit; and
displaying a setting window on the display unit, where the setting window enables a user to select either permission or prohibition for display of at least one of four messages on the preset device:
A. a first message to notify completion of printing a preset total number of required copies with regard to a certain print job by all the multiple printing devices;
B. a second message to notify occurrence of an error interfering with completion of printing in one of the multiple printing devices;
C. a third message to notify completion of printing a preset distributed number of required copies with regard to a certain print job by one of the multiple printing devices; and
D. a fourth message to notify setting of copy printing for a certain print job and specification of a total number of required copies with regard to the certain print job to be printed by the multiple printing devices.

4. A computer program product used in a specific computer equipped with at least a display unit, the computer program product being adopted in distributed printing with multiple printing devices to enable a message corresponding to an operating status of each printing device to be displayed on the specific computer or another computer,
the computer program product comprising:
a program code of displaying a setting window on the display unit, where the setting window enables a user to select either permission or prohibition for display of at least one of four messages on the specific computer or another computer:
A. a first message to notify completion of printing a preset total number of required copies with regard to a certain print job by all the multiple printing devices;
B. a second message to notify occurrence of an error interfering with completion of printing in one of the multiple printing devices;
C. a third message to notify completion of printing a preset distributed number of required copies with regard to a certain print job by one of the multiple printing devices; and
D. a fourth message to notify setting of copy printing for a certain print job and specification of a total number of required copies with regard to the certain print job to be printed by the multiple printing devices; and
a computer readable medium that stores the program code.
